(19) United States
(12) Patent Application Publication
(10) Pub. No.: US 2009/0155702 A1
(43) Pub. Date: Jun. 18, 2009

(54) METHOD FOR PRODUCING DEVELOPING AGENT

(75) Inventors: Masahiro Ikuta, Mishima-shi (JP); Takayasu Aoki, Mishima-shi (JP); Takashi Urabe, Suntou-gun (JP); Tsuyoshi Itou, Izunokuni-shi (JP); Yasuhito Noda, Mishima-shi (JP); Motonari Udo, Mishima-shi (JP); Satoshi Araki, Izunokuni-shi (JP); Takafumi Hara, Mishima-shi (JP); Asumi Matsumoto, Suntou-gun (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/330,957

(22) Filed: Dec. 9, 2008

Related U.S. Application Data
(60) Provisional application No. 61/013,470, filed on Dec. 13, 2007.

(51) Int. Cl. G03G 9/087; G03G 5/00

(52) U.S. Cl. 430/105; 430/137.14

(57) ABSTRACT

After fine particles containing a binder resin and a coloring agent are agglomerated in a dispersion liquid to form agglomerated particles, an inverting agent which inverts a sign of a zeta potential of the agglomerated particles is added to the dispersion liquid to stabilize the agglomerated particles, and then, the agglomerated particles are fused.

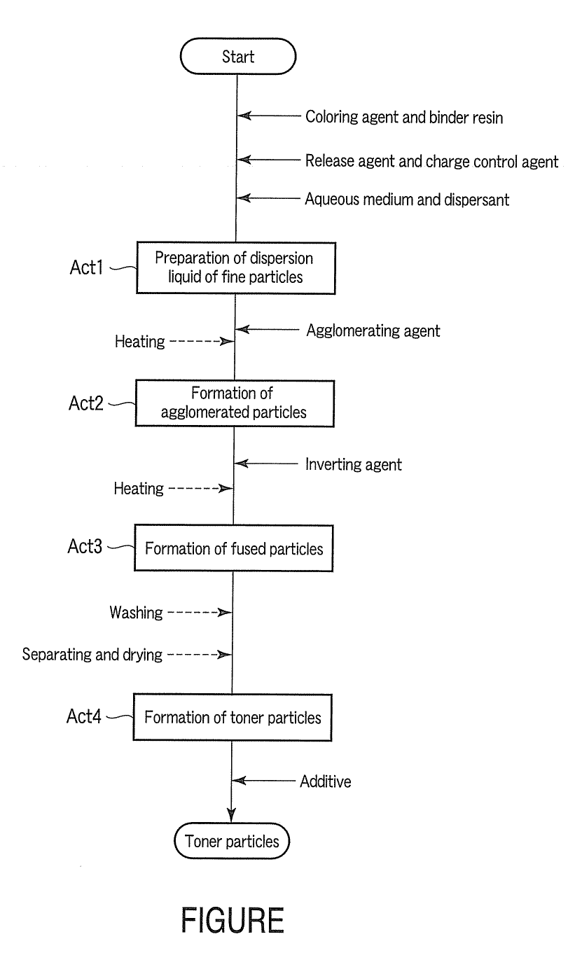

### CROSS-REFERENCE TO RELATED APPLICATION

This application is based upon and claims the benefit of priority from U.S. Provisional Application No. 61/013,470, filed Dec. 13, 2007, the entire contents of which are incorporated herein by reference.

### TECHNICAL FIELD

The present invention relates to a method for producing a developing agent for developing an electrostatic image or a magnetic latent image in electrophotography, an electrostatic printing method, a magnetic recording method, and the like.

### BACKGROUND

In the past, as a method for producing a toner capable of intentionally controlling the shape and surface composition of toner particles, an agglomeration method was proposed. In this agglomeration method, a metal salt or a polymeric agglomerating agent is added as an agglomerating agent to a dispersion liquid of fine particles containing a binder resin and a coloring agent thereby agglomerating the fine particles, followed by fusing the agglomerated particles to form toner particles. The agglomeration method using a metal salt is disclosed in, for example, JP-A-63-282752, JP-A-6-250439, and the like. The agglomeration method using a polymeric agglomerating agent is disclosed in, for example, JP-A-2003-316068 and the like.

In such an agglomeration method, reagglomeration by heating during fusion is prevented as follows. For example, in an agglomeration step, fine particles in a dispersion liquid are agglomerated by adding an agglomerating agent to the dispersion liquid to bring a negative zeta potential of the fine particles close to 0, and thereafter, in a fusion step, the dispersibility of the agglomerated particles is stabilized by adding a dispersant, for example, by adding a surfactant, or by adding a pH adjusting agent to make the pH of the dispersion liquid alkaline, resulting in increasing the absolute value of the negative zeta potential to move away from 0. However, when the agglomerated particles are stabilized with zeta potentials of the same sign in the agglomeration step and fusion step as described above, the dispersion stability is increased. Therefore, it is necessary to perform the fusion step at a higher temperature, and a problem arises that the agglomerated particles are easily redispersed.

### SUMMARY

An object of the present invention is to enable agglomerated particles to be easily fused without redispersing the agglomerated particles in a method for producing a developing agent using an agglomeration method.

The method for producing a developing agent of the invention includes:

forming agglomerated particles by adding an agglomerating agent to a dispersion liquid of fine particles containing a binder resin and a coloring agent to agglomerate the fine particles;

forming fused particles by adding an inverting agent which inverts a sign of a zeta potential of the agglomerated particles to the dispersion liquid to stabilize the agglomerated particles, and then, heating the dispersion liquid to fuse the agglomerated particles; and

obtaining toner particles by washing and separating the fused particles.

The developing agent of the invention contains toner particles obtained by agglomerating fine particles containing a binder resin and a coloring agent in a dispersion liquid, adding an inverting agent which inverts a sign of a zeta potential of the agglomerated particles to the dispersion liquid containing the agglomerated particles to stabilize the agglomerated particles, followed by fusing the agglomerated particles.

By using the method for producing a developing agent of the invention, agglomerated particles can be easily fused without redispersing the agglomerated particles, and a favorable developing agent can be obtained.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawing, which is incorporated in and constitutes a part of the specification, illustrates embodiments of the invention, and together with the general description given above and the detailed description of the embodiments given below, serves to explain the principles of the invention.

The single FIGURE is a flow diagram for illustrating one example of a method for producing a developing agent of the invention.

### DETAILED DESCRIPTION

The method for producing a developing agent of the present invention is a method including:

forming agglomerated particles by adding an agglomerating agent to a dispersion liquid of fine particles containing a binder resin and a coloring agent to agglomerate the fine particles;

forming fused particles by adding an additive to a dispersion liquid to stabilize the agglomerated particles, and then, heating the dispersion liquid to fuse the agglomerated particles; and

obtaining toner particles by washing and separating the fused particles.

In the method, as the additive, an inverting agent which inverts a sign of a zeta potential of the agglomerated particles is added.

Further, the developing agent of the invention is a developing agent obtained by the above-mentioned method and contains toner particles obtained by agglomerating fine particles containing a binder resin and a coloring agent in a dispersion liquid, stabilizing the agglomerated particles, and then fusing the agglomerated particles. The agglomerated particles are stabilized by adding an inverting agent which inverts a sign of a zeta potential of the agglomerated particles to the dispersion liquid containing agglomerated particles.

Here, the “inverting agent” means an additive which not only brings the zeta potential of the agglomerated particles closer to 0 from the zeta potential of the agglomerated particles during agglomeration, but also inverts the zeta potential of the agglomerated particles such that the zeta potential crosses 0 and has a different sign, and is different from a dispersant which increases the absolute value of the zeta potential of the same sign as that of the zeta potential during agglomeration.

For example, by adding as the inverting agent, an ionic surfactant or an ionic polymeric compound with an opposite electrical charge to that of the particles after addition of the agglomerating agent, that is, when the particles are anionic, a cationic surfactant or a cationic polymeric compound, when the particles are cationic, an anionic surfactant or an anionic polymeric compound, the sign of the zeta potential after addition of the agglomerating agent is made different from that of the zeta potential after completion of fusion, and thus, the dispersion stability can be increased.

According to the invention, by performing a treatment in which the inverting agent is added to a dispersion liquid containing agglomerated particles to allow the zeta potential of the agglomerated particles to cross 0 and have a different sign at least once, a distance between fine particles to form agglomerated particles decreases at a zeta potential of around 0 mV and the fine particles are firmly agglomerated. Therefore, even if the zeta potential is increased to disperse the respective agglomerated particles after the treatment, the agglomerated particles are difficult to be redispersed.

A range of the zeta potential after inversion by the addition of the inverting agent is preferably as follows.
   |1351|≦zeta potential after addition of inverting agent (mV) <1501

When the absolute value of the zeta potential is less than 35, coalescence by heating during fusion proceeds. On the other hand, when the absolute value of the zeta potential is more than 50, the dispersion stability of the agglomerated particles becomes too high, and redispersion is caused.

Further, when the method of the invention is used, it is not necessary to heat the dispersion liquid to a temperature higher than that in the case where agglomerated particles are fused with a zeta potential of the same sign as that of a zeta potential at completion of the agglomeration, and the fusion can be performed at a low temperature, and thus, the agglomerated particles can be prevented from redispersing.

The FIGURE is a flow diagram for illustrating one example of a method for producing a developing agent of the invention.

As shown in the drawing, in the method of the invention, first, a toner material containing a coloring agent and a binder resin, optionally a release agent, a charge control agent, or the like are mixed with an aqueous medium, a dispersant such as an anionic surfactant, a neutralizing agent, and the like, and a dispersion liquid of fine particles is prepared by, for example, a phase inversion emulsification method, a method capable of providing mechanical shearing, or the like (Act 1). The fine particles preferably have a volume average particle size of from 0.01 to 1.5 μm. It is difficult to form particles having a volume average particle size less than 0.01 μm, and when the volume average particle size exceeds 1.5 μm, it is difficult to form agglomerated particles having a volume average particle size of from 3 to 10 μm.

Thereafter, an agglomerating agent is added to the dispersion liquid of fine particles, and the resulting mixture is heated thereby forming agglomerated particles having a volume average particle size of from 3 to 10 μm (Act 2).

An inverting agent is added to the dispersion liquid containing the agglomerated particles to allow the zeta potential of the agglomerated particles to cross 0 and have a different sign, and the resulting mixture is heated to fuse the agglomerated particles thereby forming fused particles having a volume average particle size of from 3 to 10 μm (Act 3).

The thus obtained fused particles are washed, separated, and dried thereby obtaining toner particles (Act 4).

To the surface of the toner particles, an additive such as a hydrophobic silica or titanium oxide is attached thereby obtaining a toner.

In the case of a one-component developing agent, the toner can be used as a developing agent as such.

In the case of a two-component developing agent, the toner can be used as a developing agent by being mixed with a carrier.

As a material to be used in the invention, any known material such as a binder resin, a coloring agent, a release agent, a charge control agent, a polymeric compound, an agglomerating agent, an inverting agent, or a neutralizing agent can be used.

Examples of the binder resin to be used in the invention include styrene resins such as polystyrene, styrene-butadiene copolymers, and styrene-acrylic copolymers, ethylene resins such as polyethylene, polyethylene-vinyl acetate copolymers, polyethylene-norbornene copolymers, and polyethylene-vinyl alcohol copolymers, polyester resins, acrylic resins, phenol resins, epoxy resins, allyl phthalate resins, polyamide resins, and maleic acid resins. These binder resins may be used alone or in combination of two or more types.

The binder resin preferably has an acid value of 1 or more.

Examples of the coloring agent to be used in the invention include carbon blacks, and organic or inorganic pigments or dyes. Examples of the carbon black include acetylene black, furnace black, thermal black, channel black, and Ketjen black. Further, examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185, and C.I. Vat Yellow 1, 3, and 20. These can be used alone or in admixture. Further, examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 238, C.I. Pigment Violet 19, and C.I. Vat Red 1, 2, 10, 13, 15, 23, 29, and 35. These can be used alone or in admixture. Further, examples of a cyan pigment include C.I. Pigment Blue 2, 3, 15, 16, and 17, C.I. Vat Blue 6, C.I. Acid Blue 45, and copper phthalocyanine pigments. These can be used alone or in admixture.

Examples of the release agent to be used in the invention include aliphatic hydrocarbon waxes such as low molecular weight polyethylene, low molecular weight polypropylene, polyolefin copolymers, polyolefin waxes, microcrystalline waxes, paraffin waxes, and Fischer-Tropsch waxes, oxides of an aliphatic hydrocarbon wax such as polyethylene oxide wax or block copolymers thereof, vegetable waxes such as candelilla wax, carnauba wax, Japan wax, jojoba wax, and rice wax, animal waxes such as bees wax, lanolin, and whale wax, mineral waxes such as ozokerite, ceresin, and petrolatum, waxes containing, as the major component, a fatty acid ester such as montanic acid ester wax and castor wax, and deoxidation products resulting from deoxidization of a part or the whole of a fatty acid ester such as deoxidized carnauba wax. Further, saturated linear fatty acids such as palmitic acid, stearic acid, montanic acid, and long-chain alkyl carboxylic acids having a long-chain alkyl group, unsaturated fatty acids such as brassidic acid, eleostearic acid, and parinaric acid, saturated alcohols such as stearyl alcohol, eicosyl alcohol, behenyl alcohol, carnaubyl alcohol, ceryl alcohol, melissyl alcohol, and long-chain alkyl alcohols having a long-chain alkyl group, polyhydric alcohols such as sorbitol, fatty acid amides such as linoleic acid amide, oleic acid amide, and lauric acid amide, saturated fatty acid bisamides such as methylenebisstearic acid amide, ethylenebiscaprylic acid amide, ethylenebislauric acid amide, and hexamethylenebisstearic acid amide, unsaturated fatty acid amides such as ethylenebisoleic acid amide, hexamethylenebisoleic acid amide, N,N′-dioleyladipic acid amide, and N,N′-dioleylsebaccic acid amide, aromatic bisamides such as m-xylenebisstearic acid amide, and N,N′-distearylisophthalic acid amide, fatty acid metal salts (generally called metallic soaps) such as calcium stearate, calcium laurate, zinc stearate, and magnesium stearate, waxes obtained by grafting of a vinyl monomer such as styrene or acrylic acid on an aliphatic hydrocarbon wax, partially esterified products of a fatty acid and a polyhydric alcohol such as behenic acid monoglyceride, and methyl ester compounds having a hydroxyl group obtained by hydrogenation of a vegetable fat and oil can be exemplified.

Further, as the charge control agent for controlling a frictional charge quantity which can be used in the invention, for example, a positively charged charge control agent such as a nigrosine dye, a quaternary ammonium compound, or a polyamine resin, or a metal-containing azo compound is used. Further, a complex or a complex salt in which the metal element is iron, cobalt, or chromium, or a mixture thereof, or a metal-containing salicylic acid derivative compound can also be used, and a negatively charged charge control agent such as a complex or a complex salt in which the metal element is zirconium, zinc, chromium, or boron, or a mixture thereof can be used.

Examples of the surfactant which can be used in the invention include anionic surfactants such as sulfate-based, sulfonate-based (such as sodium dodecylbenzene sulfonate), phosphate-based, and soap-based anionic surfactants, cationic surfactants such as amine salt-type and quaternary ammonium salt-type cationic surfactants, and nonionic surfactants such as polyethylene glycol-based, alkyl phenol ethylene oxide adduct-based, and polyhydric alcohol-based nonionic surfactants.

Examples of the polymeric compound which can be used in the invention include anionic polymeric compounds such as polycarboxylate salts, polymethacrylate salts, and polyacrylate salts. Examples of such salts include alkali metal salts (such as lithium, sodium, and potassium), alkaline earth metal salts (such as magnesium and calcium), and amine salts (such as ammonium). Further, cationic polymeric compounds such as amino alkyl (meth)acrylate salts and poly(diallyl ammonium salts) can be exemplified. Examples of such salts include hydrochlorides, sulfates, nitrates, and methyl chloride salts.

Examples of the agglomerating agent which can be used in the agglomeration step of the invention include metal salts such as sodium chloride, calcium chloride, calcium nitrate, barium chloride, magnesium chloride, zinc chloride, magnesium sulfate, aluminum chloride, aluminum sulfate, and potassium aluminum sulfate, inorganic metal salt polymers such as poly(aluminum chloride), poly(aluminum hydroxide), and calcium polysulfide, polymeric agglomerating agents such as polymethacrylic esters, polyacrylic esters, polyacrylamides, and acrylamide sodium acrylate copolymers, coagulating agents such as polyamines, poly(diallyl ammonium halides) (such as poly(diallyl dimethyl ammonium chloride) and poly(dimethyl hydroxypropyl ammonium chloride)), melanin formaldehyde condensates, and dicyandiamide, alcohols such as methanol, ethanol, 1-propanol, 2-propanol, 2-methyl-2-propanol, 2-methoxyethanol, 2-ethoxyethanol, and 2-butoxyethanol, organic solvents such as acetonitrile and 1,4-dioxane, inorganic acids such as hydrochloric acid and nitric acid, and organic acids such as formic acid and acetic acid.

The inverting agent which can be used in the invention can be selected from the above-mentioned surfactants and coagulating agents.

As the neutralizing agent which can be used in the invention, an inorganic base or an amine compound can be used. Examples of the inorganic base include sodium hydroxide and potassium hydroxide. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane.

As a method for preparing a dispersion liquid of fine particles containing at least a binder resin and a coloring agent, and optionally containing a release agent, the use of a mechanical shearing device, a phase inversion emulsification method, or the like can be exemplified.

As the mechanical shearing device to be used in the invention, any known device can be used. Examples of the device include medium-free stirrers such as ULTRA TURRAX (manufactured by IKA Japan K.K.), T.K. AUTO HOMO MIXER (manufactured by PRIMIX Corporation), T.K. PIPELINE HOMO MIXER (manufactured by PRIMIX Corporation), T.K. FILMICS (manufactured by PRIMIX Corporation), CLEAR MIX (manufactured by M TECHNIQUE Co., Ltd.), CLEAR SS5 (manufactured by M TECHNIQUE Co., Ltd.), CAVITRON (manufactured by EUROTEC, Ltd.), and FINE FLOW MILL (manufactured by Pacific Machinery & Engineering Co., Ltd.), medium stirrers such as VISCO MILL (manufactured by Aimex Co., Ltd.), APEX MILL (manufactured by Kotobuki Industries Co., Ltd.), STAR MILL (manufactured by Ashizawa Finetech Co., Ltd.), DCP SUPER FLOW (manufactured by Nippon Eirich Co., Ltd.), MP MILL (manufactured by Inoue Manufacturing Co., Ltd.), SPIKE MILL (manufactured by Inoue Manufacturing Co., Ltd.), MIGHTY MILL (manufactured by Inoue Manufacturing Co., Ltd.), and SC MILL (manufactured by Mitsui Mining Co., Ltd.), and high-pressure impact-type dispersing devices such as Ultimizer (manufactured by Sugino Machine Limited), Nanomizer (manufactured by Yoshida Kikai Co. Ltd.), and NANO 3000 (manufactured by Beryu Co., Ltd.).

### EXAMPLES

Hereinafter, the present invention will be more specifically described with reference to Examples.

In the Examples, physical properties and particle sizes of toners were determined by the methods shown below.

### Method for Measuring Zeta Potential

A zeta potential is measured using a zeta potential analyzer ZEECOM (manufactured by Microtech Nition Co., Ltd.).

A test sample is prepared with ion exchanged water such that a solid content is 5 ppm. A cell position is set to 15 mm, and a voltage is set to 70 V, and 50 particles were randomly selected and measured. A mean measurement value is determined to be a zeta potential. Method for measuring particle size of fine particles A particle size of fine particles in a dispersion liquid is measured using SALD-7000 manufactured by Shimadzu Corporation.

### Method for Measuring Particle Size of Toner Particles

A particle size of toner particles is measured using Multisizer 3 with an aperture size of 100 μm manufactured by Beckman Coulter Inc.

### Determination for Redispersion

A dispersion liquid after completion of fusion is centrifuged at 6000 rpm for 30 minutes using a centrifuge CN-2060 (manufactured by AS ONE Co., Ltd.), and redispersion was determined by visually observing the resulting supernatant.

### Preparation of Dispersion Liquid of Fine Particles Containing Resin, Pigment, and Release Agent

90 parts by weight of a polyester resin as a binder resin, 5 parts by weight of a copper phthalocyanine pigment as a coloring agent, and 5 parts by weight of an ester wax as a release agent were mixed, and the resulting mixture was melt-kneaded using a twin screw kneader whose temperature was set to 120° C., whereby a kneaded material was obtained.

The thus obtained kneaded material was coarsely pulverized to a volume average particle size of 1.2 mm using a hammer mill manufactured by Nara Machinery Co., Ltd., whereby coarse particles were obtained.

The thus obtained coarse particles were moderately pulverized to a volume average particle size of 0.05 mm using a bantam mill manufactured by Hosokawa Micron Corporation, whereby moderately pulverized particles were obtained. 40 parts by weight of the thus obtained moderately pulverized particles, 4 parts by weight of sodium dodecylbenzene sulfonate as an anionic surfactant, 1 part by weight of triethylamine as an amine compound, and 55 parts by weight of ion exchanged water were processed at 160 MPa and 180 ° C. using NANO 3000, whereby a dispersion liquid of fine particles having a volume average particle size of 450 nm was obtained.

### Example 1

### Agglomeration Step

25 parts by weight of the above-mentioned dispersion liquid and 65 parts by weight of ion exchanged water were mixed. 10 parts by weight of 5% by weight of an aqueous solution of aluminum sulfate was added thereto as a metal salt at 30° C. The zeta potential of the agglomerated particles after the addition of the metal salt was −28.87 mV. The temperature was raised to 50° C. after the addition of the metal salt.

### Fusion Step

In order to maintain the volume average particle size of the thus obtained agglomerated particles, 20 parts by weight of 10% by weight of poly(diallyl dimethyl ammonium chloride) was added thereto as an inverting agent. The zeta potential of the agglomerated particles after the addition of the inverting agent was 37.59 mV. After the addition of the inverting agent, in order to control the shape of the agglomerated particles, the temperature was raised to 90° C. and the dispersion liquid was left as such for 2 hours.

When a supernatant obtained by centrifuging a portion of the dispersion liquid was examined, a good result in which white turbidity was not observed, was obtained.

### Washing and Drying Step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 5.21 μm.

### Example 2

### Agglomeration Step

25 parts by weight of the above-mentioned dispersion liquid and 65 parts by weight of ion exchanged water were mixed. 10 parts by weight of 5% by weight of an aqueous solution of aluminum sulfate was added thereto as a metal salt at 30° C. The zeta potential of the agglomerated particles after the addition of the metal salt was −28.54 mV. The temperature was raised to 50° C. after the addition of the metal salt.

### Fusion Step

In order to maintain the volume average particle size of the thus obtained agglomerated particles, 20 parts by weight of 10% by weight of poly(dimethyl hydroxypropyl ammonium chloride) was added thereto as an inverting agent. The zeta potential of the agglomerated particles after the addition of the inverting agent was 40.23 mV. After the addition of the inverting agent, in order to control the shape of the agglomerated particles, the temperature was raised to 90° C. and the dispersion liquid was left as such for 2 hours.

When a supernatant obtained by centrifuging a portion of the dispersion liquid was examined, a good result in terms of redispersion was obtained.

### Washing and Drying Step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 4.86 μm.

### Example 3

### Agglomeration Step

25 parts by weight of the above-mentioned dispersion liquid and 65 parts by weight of ion exchanged water were mixed. 10 parts by weight of 10% by weight of an aqueous solution of magnesium sulfate was added thereto as a metal salt at 30 ° C. The zeta potential of the agglomerated particles after the addition of the metal salt was −25.65 mV. The temperature was raised to 60° C. after the addition of the metal salt.

### Fusion Step

In order to maintain the volume average particle size of the thus obtained agglomerated particles, 20 parts by weight of 10% by weight of poly(diallyl dimethyl ammonium chloride) was added thereto as an inverting agent. The zeta potential of the agglomerated particles after the addition of the inverting agent was 39.74 mV. After the addition of the inverting agent, in order to control the shape of the agglomerated particles, the temperature was raised to 90° C. and the dispersion liquid was left as such for 2 hours.

When a supernatant obtained by centrifuging a portion of the dispersion liquid was examined, a good result in terms of redispersion was obtained. Washing and drying step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 5.34 μm.

### Comparative Example 1

### Agglomeration Step

25 parts by weight of the above-mentioned dispersion liquid and 65 parts by weight of ion exchanged water were mixed. 10 parts by weight of 5% by weight of an aqueous solution of aluminum sulfate was added thereto as a metal salt at 30° C. The zeta potential of the agglomerated particles after the addition of the metal salt was −28.67 mV. The temperature was raised to 50° C. after the addition of the metal salt.

### Fusion Step

In order to maintain the volume average particle size of the thus obtained agglomerated particles, 30 parts by weight of 10% by weight of sodium polycarboxylate was added thereto as a dispersant. The zeta potential of the agglomerated particles after the addition of the dispersant was −42.67 mV. After the addition of the dispersant, in order to control the shape of the agglomerated particles, the temperature was raised to 98° C. and the dispersion liquid was left as such for 2 hours.

When a supernatant obtained by centrifuging a portion of the dispersion liquid was examined, a result in which white turbidity was caused due to redispersion was obtained.

### Washing and Drying Step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 5.09 μm.

### Comparative Example 2

### Agglomeration Step

25 parts by weight of the above-mentioned dispersion liquid and 65 parts by weight of ion exchanged water were mixed. 10 parts by weight of 5% by weight of an aqueous solution of aluminum sulfate was added thereto as a metal salt at 30° C. The zeta potential of the agglomerated particles after the addition of the metal salt was −26.49 mV. The temperature was raised to 50° C. after the addition of the metal salt.

### Fusion Step

In order to maintain the volume average particle size of the thus obtained agglomerated particles, 30 parts by weight of 10% by weight of a sodium alkyl sulfate was added thereto as a dispersant. The zeta potential of the agglomerated particles after the addition of the dispersant was −41.27 mV. After the addition of the dispersant, in order to control the shape of the agglomerated particles, the temperature was raised to 98° C. and the dispersion liquid was left as such for 2 hours.

When a supernatant obtained by centrifuging a portion of the dispersion liquid was examined, a result in which white turbidity was caused due to redispersion was obtained.

### Washing and Drying Step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 5.89 μm.

### Comparative Example 3

### Agglomeration Step

25 parts by weight of the above-mentioned dispersion liquid and 65 parts by weight of ion exchanged water were mixed. 10 parts by weight of 5% by weight of an aqueous solution of aluminum sulfate was added thereto as a metal salt at 30° C. The zeta potential of the agglomerated particles after the addition of the metal salt was −27.62 mV. The temperature was raised to 50° C. after the addition of the metal salt.

### Fusion Step

In order to maintain the volume average particle size of the thus obtained agglomerated particles, 15 parts by weight of 10% by weight of sodium hydroxide was added thereto as a dispersant. The zeta potential of the agglomerated particles after the addition of the dispersant was −35.12 mV. After the addition of the dispersant, in order to control the shape of the agglomerated particles, the temperature was raised to 100° C. and the dispersion liquid was left as such for 2 hours.

When a supernatant obtained by centrifuging a portion of the dispersion liquid was examined, a result in which white turbidity was caused due to redispersion was obtained.

### Washing and Drying Step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 5.37 μm.

### Comparative Example 4

### Agglomeration Step

25 parts by weight of the above-mentioned dispersion liquid and 65 parts by weight of ion exchanged water were mixed. 10 parts by weight of 5% by weight of an aqueous solution of aluminum sulfate was added thereto as a metal salt at 30° C. The zeta potential of the agglomerated particles after the addition of the metal salt was −28.21 mV. The temperature was raised to 50° C. after the addition of the metal salt.

### Fusion Step

In order to maintain the volume average particle size of the thus obtained agglomerated particles, 15 parts by weight of 10% by weight of Poly(diallyl dimethyl ammonium chloride) was added thereto as an inverting agent. The zeta potential of the agglomerated particles after the addition of the inverting agent was 32.81 mV. After the addition of the inverting agent, in order to control the shape of the agglomerated particles, the temperature was raised to 90° C. and the dispersion liquid was left as such for 2 hours. Coalescence of the agglomerated particles was observed.

When a supernatant obtained by centrifuging a portion of the dispersion liquid was examined, a good result in terms of redispersion was obtained.

### Washing and Drying Step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 27.7 μm.

### Comparative Example 5

### Agglomeration Step

25 parts by weight of the above-mentioned dispersion liquid and 65 parts by weight of ion exchanged water were mixed. 10 parts by weight of 5% by weight of an aqueous solution of aluminum sulfate was added thereto as a metal salt at 30° C. The zeta potential of the agglomerated particles after the addition of the metal salt was −28.63 mV. The temperature was raised to 50° C. after the addition of the metal salt.

### Fusion Step

In order to maintain the volume average particle size of the thus obtained agglomerated particles, 40 parts by weight of 10% by weight of Poly(diallyl dimethyl ammonium chloride) was added thereto as an inverting agent. The zeta potential of the agglomerated particles after the addition of the inverting agent was 51.92 mV. After the addition of the inverting agent, redispersion was caused, therefore, the toner preparation was discontinued.

When a supernatant obtained by centrifuging a portion of the dispersion liquid was examined, the supernatant was turbid.

### Comparative Example 6

### Agglomeration Step

25 parts by weight of the above-mentioned dispersion liquid and 65 parts by weight of ion exchanged water were mixed. 10 parts by weight of 10% by weight of an aqueous solution of magnesium sulfate was added thereto as a metal salt at 30° C. The zeta potential of the agglomerated particles after the addition of the metal salt was −25.68 mV. The temperature was raised to 60° C. after the addition of the metal salt.

### Fusion Step

In order to maintain the volume average particle size of the thus obtained agglomerated particles, 20 parts by weight of 10% by weight of sodium polycarboxylate was added thereto as a dispersant. The zeta potential of the agglomerated particles after the addition of the dispersant was −40.22 mV. After the addition of the dispersant, in order to control the shape of the agglomerated particles, the temperature was raised to 90° C. and the dispersion liquid was left as such for 2 hours.

When a supernatant obtained by centrifuging a portion of the dispersion liquid was examined, a result in which white turbidity was caused due to redispersion was obtained.

### Washing and Drying Step

After the dispersion liquid was cooled, the solids in the cooled dispersion liquid were washed by repeating a procedure in which the dispersion liquid was centrifuged using a centrifuge, the resulting supernatant was removed, and the remaining solids were washed with ion exchanged water until the electrical conductivity of the supernatant became 50 μS/cm. Thereafter, the resulting solids were dried using a vacuum dryer until the water content became 0.3% by weight, whereby toner particles were obtained.

After drying, 2 parts by weight of hydrophobic silica and 0.5 part by weight of titanium oxide were attached as additives to the surface of the toner particles, whereby a desired electrophotographic toner was obtained.

The volume average particle size of the thus obtained electrophotographic toner was measured using Multisizer 3 manufactured by Beckman Coulter Inc. and found to be 5.18 μm.

The results of the above-mentioned Examples and Comparative examples are shown in the following Table 1.

TABLE 1

| | | | | Zeta potential | | | | |
|---|---|---|---|---|---|---|---|---|
| | | | | after | | | | |
| | | | | addition of | | | | |
| | | | | agglomerating | Zeta potential | Particle size of | | |
| | Binder | Agglomerating | Inverting agent or | agent | after fusion | toner particles | Fusion | |
| | resin | agent | dispersant | (mV) | (mV) | (μm) | temperature | Redispersion |
| Example 1 | Polyester | Aluminum sulfate | Poly(diallyl dimethyl | −28.87 | 37.59 | 5.21 | 90 | ◯◯ |
| | | | ammonium chloride) | | | | | |
| Example 2 | Polyester | Aluminum sulfate | Poly(dimethyl | −28.54 | 40.23 | 4.86 | 90 | ◯◯ |
| | | | hydroxypropyl | | | | | |
| | | | ammonium chloride) | | | | | |
| Example 3 | Polyester | Magnesium sulfate | Poly(diallyl dimethyl | −25.68 | 39.74 | 5.34 | 90 | ◯ |
| | | | ammonium chloride) | | | | | |
| Comparative | Polyester | Aluminum sulfate | Sodium | −28.67 | −42.67 | 5.09 | 98 | Δ |
| example 1 | | | polycarboxylate | | | | | |
| Comparative | Polyester | Aluminum sulfate | Sodium alkyl sulfate | −26.49 | −41.27 | 5.89 | 98 | Δ |
| example 2 | | | | | | | | |
| Comparative | Polyester | Aluminum sulfate | NaOH | −27.62 | −35.21 | 5.37 | 100 | X |
| example 3 | | | | | | | | |
| Comparative | Polyester | Aluminum sulfate | Poly(diallyl dimethyl | −28.21 | 32.81 | 28.7 | 90 | ◯◯ |
| example 4 | | | ammonium chloride) | | | | | |
| Comparative | Polyester | Aluminum sulfate | Poly(diallyl dimethyl | −28.63 | 51.98 | — | — | X |
| example 5 | | | ammonium chloride) | | | | | |
| Comparative | Polyester | Magnesium sulfate | Sodium | −25.68 | −40.22 | 5.18 | 98 | X |
| example 6 | | | polycarboxylate | | | | | |

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for producing a developing agent comprising:
adding an agglomerating agent to a dispersion liquid of fine particles containing a binder resin and a coloring agent and having a first particle size to agglomerate the fine particles to form agglomerated particles having a second particle size larger than the first particle size;
forming fused particles by adding an inverting agent which inverts a sign of a zeta potential of the agglomerated particles to the dispersion liquid to stabilize the agglomerated particles, and then, heating the dispersion liquid to fuse the agglomerated particles; and
obtaining toner particles by washing and separating the fused particles.

2. The method according to claim 1, wherein when the zeta potential of the agglomerated particles in the dispersion liquid is negative, the inverting agent contains at least one of a cationic surfactant and a cationic polymeric compound.

3. The method according to claim 1, wherein when the zeta potential of the agglomerated particles in the dispersion liquid is positive, the inverting agent contains at least one of an anionic surfactant and an anionic polymeric compound.

4. The method according to claim 1, wherein the agglomerating agent contains at least one member selected from the group consisting of a metal salt, a polymeric agglomerating agent, a coagulating agent, an acid, a surfactant with an opposite electrical charge, and an organic solvent.

5. The method according to claim 1, wherein the developing agent obtained using the toner particles has a positive electrical charge.

6. The method according to claim 1, wherein the fine particles further contain a release agent.

7. A developing agent comprising toner particles obtained by agglomerating fine particles containing a binder resin and a coloring agent and having a first particle size in a dispersion liquid, adding an inverting agent which inverts a sign of a zeta potential of the agglomerated particles having a second particle size larger than the first particle size to the dispersion liquid containing the agglomerated particles to stabilize the agglomerated particles, followed by fusing the agglomerated particles.
